(19) United States
(12) Patent Application Publication
(10) Pub. No.: US 2007/0109657 A1
(43) Pub. Date: May 17, 2007

(54) System and method for providing a three dimensional image

(76) Inventor: Byoungyi Yoon, Ulsan Gwang-yeok-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/280,191

(22) Filed: Nov. 15, 2005

(51) Int. Cl. G02B 27/10

(52) U.S. Cl. 359/627

(57) ABSTRACT

A system for providing a three dimensional image from at least two plane images is disclosed. In one embodiment, the system comprises i) first and second image display devices substantially simultaneously outputting first and second plane images, each plane image produced at different positions with respect to an object, ii) a first mirror configured such that the output first plane image is incident to the first mirror and reflected in a direction, iii) a second mirror configured such that the output second plane image is incident to the second mirror and reflected in the direction, and iv) an adjustment mechanism configured to either manually or automatically adjust the distance between the first and second mirrors based on the distance between the center points of a viewer's eyes. In one embodiment, the first and second display devices are located on opposite sides of the first and second mirrors.

### BACKGROUND OF THE INVENTION

1. Field of the Invention

The present invention relates to a method and system for providing a three dimensional (3-D) image, and more particularly, to a method and system for providing a 3-D image based on a viewer's eye distance.

2. Description of the Related Technology

A 3-D image provides a viewer with a sense of depth and distance between objects, as well as a sense of three dimensions with respect to each object (e.g., person). Presently, most images are only two dimensional and various studies have been carried out to determine how to overcome their lack of a depth component.

Most technologies which enable the perception of a 3-D image are based on the fact that a human being has two eyes. The principle of this perception is that the eyes are horizontally spaced apart a predetermined distance from each other. For example, the distance is about 7.5 cm and 5 cm for adults and children, respectively, such that images of a scene received at the retinas are views from different angles. An image of the object one sees is transferred to the cerebrum via a visual nerve.

Thus, in a conventional method of providing a 3-D image to a viewer, two images are presented in a shutter or refraction manner so as to be seen independently by the left and right eyes.

Although there is a conventional method of realizing a 3-D image by using LCD eyeglasses, this additional apparatus is not widely available and is costly. Even when this conventional apparatus is used, if separation of the left and right images is not complete, images overlap each other or the image flickers due to the phenomenon of optical interference.

### SUMMARY OF CERTAIN INVENTIVE ASPECTS

One aspect of the invention provides a system for providing a three dimensional image from at least two plane images. In one embodiment, the system comprises i) first and second image display devices configured to substantially simultaneously output first and second plane images, each plane image produced at different positions with respect to an object, ii) a first mirror configured such that the output first plane image is incident to the first mirror and reflected in a selected direction, iii) a second mirror configured such that the output second plane image is incident to the second mirror and reflected in the selected direction, and iv) an adjustment mechanism configured to adjust the distance between the first and second mirrors, wherein the first and second display devices are located on opposite sides of the first and second mirrors.

Another aspect of the invention provides a method of providing a three dimensional image from at least two plane images. In one embodiment, the method comprises i) substantially simultaneously outputting first and second plane images, each plane image produced at different positions with respect to an object, ii) configuring a first mirror such that the output first plane image is incident to the first mirror and reflected in a direction, iii) configuring a second mirror such that the output second plane image is incident to the second mirror and reflected in the direction, and iv) adjusting the distance between the first and second mirrors such that the distance between the center points of a viewer's eyes is equal to or substantially the same as the distance between the center points of the displayed images.

Another aspect of the invention provides a system for providing a three dimensional image from at least two plane images. In one embodiment, the system comprises i) a first image display device configured to output a first plane image of an object, ii) a second image display device configured to output a second plane image of the object, the first and second images being produced at different positions with respect to the object, wherein the first and second image display devices are configured to output substantially simultaneously the first image and the second image, respectively, iii) a mirror arranged such that the first plane image is incident from the first image display device to the mirror and reflected in a selected direction, and iv) an adjustment mechanism configured to adjust the distance between the mirror and the second image display device based on the distance between the center points of a viewer's eyes, wherein the first and second display devices are located on opposite sides of the mirror, and wherein the second display device is arranged to output the second plane image in the selected direction.

### BRIEF DESCRIPTION OF THE DRAWINGS

FIG. 1A illustrates a typical configuration of a system for providing a 3-D image using a pair of plane mirrors.

FIG. 1B is conceptual diagram for explaining the distance between the center points of each plane image displayed on the mirrors.

FIG. 2 illustrates a 3-D image generation system according to one embodiment of the invention.

FIG. 3A-3C illustrate an exemplary configuration of a moving mechanism of a 3-D image generation system according to one embodiment of the invention.

FIG. 4A-4B illustrate an exemplary configuration of a moving mechanism of a 3-D image generation system according to another embodiment of the invention.

FIG. 5 illustrates an exemplary configuration of a 3-D image generation system according to still another embodiment of the invention.

FIG. 6 illustrates an exemplary configuration of a moving mechanism of a 3-D image generation system according to still another embodiment of the invention.

FIG. 7 illustrates an exemplary configuration of a 3-D image generation system according to still another embodiment of the invention.

FIG. 8 illustrates an exemplary configuration of a 3-D image generation system according to still another embodiment of the invention.

FIG. 9A illustrates an exemplary configuration of a 3-D image generation system according to yet another embodiment of the invention.

FIGS. 9B and 9C are conceptual diagrams for explaining the distance adjustment between the mirrors according to one embodiment of the invention.

### DESCRIPTION OF CERTAIN INVENTIVE EMBODIMENTS

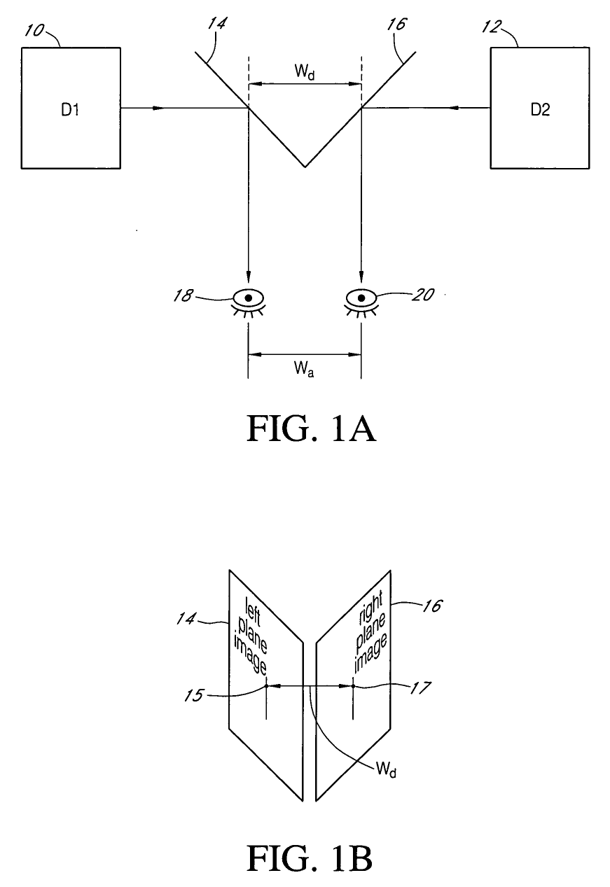

Referring to FIG. 1A, a pair of plane or 2-D display devices 10 and 12 (D1, D2) are located on opposite sides of first and second mirrors 14 and 16. In one embodiment, the display devices 10 and 12 output first and second plane images to the first and second mirrors 14 and 16, respectively. In one embodiment, each plane image is produced at different positions with respect to an object by a pair of stereoscopic cameras (not shown), and the first and second plane images form a set of stereoscopic images. In one embodiment, the plane images may be inverted, before outputting, in the display devices 10 and 12. The first and second plane images, output from the first and second display devices 10 and 12, respectively, are incident to the first and second mirrors 14 and 16, respectively. Each of the mirrors 14 and 16 reflects the incident images toward a viewer's left and right eyes 18 and 20, respectively, as shown in FIG. 1A. The viewer can synthesize the two plane images and perceive a three-dimensional image. The detailed operation of an embodiment of the FIG. 1 system is disclosed in U.S. Pat. No. 6,778,253 issued on Aug. 17, 2004, which is hereby incorporated by reference.

Referring to FIGS. 1A and 1B, distance (W_{d}) represents the distance between the center points 15 and 17 of each of the plane images displayed on the mirrors 14, 16. In one embodiment, the center points 15 and 17 of each of the plane images can be the center points of the first and second plane mirrors 14 and 16 as shown in FIG. 1B. In this embodiment, W_{d} is the distance between the center points of each of the mirrors 14 and 16.

Referring to FIG. 1A, Wₐ represents the distance between the center points of each of a viewer's eyes 18 and 20. The distance Wₐ varies from person to person. Normally the distance increases as a person grows and it does not change when he or she reaches a certain age. The average distance of an adult may be 70 mm. Some people may have a distance of 80 mm, other people may have a distance of 60 mm. There may be several methods to measure and provide the distance (Wₐ) as described in detail in Applicant's (published) U.S. application Ser. No. 10/280,246, filed on Oct. 24, 2002, which is hereby incorporated by reference.

The display system shown in FIG. 1A provides a 3-D image without considering the value Wₐ. This means that the distance value (W_{d}) is fixed to be the same for all viewers regardless of the fact that they have a different Wₐ value. This may cause several undesirable problems such as headaches or dizziness, and deterioration of a sense of three dimension. In order to produce a more realistic three-dimensional image and to reduce headaches or dizziness of a viewer, the mirror distance or two plane image distance W_{d} is preferable to be determined by considering the distance Wₐ. The consideration of the Wₐ value may provide a viewer with better and more realistic three-dimensional images.

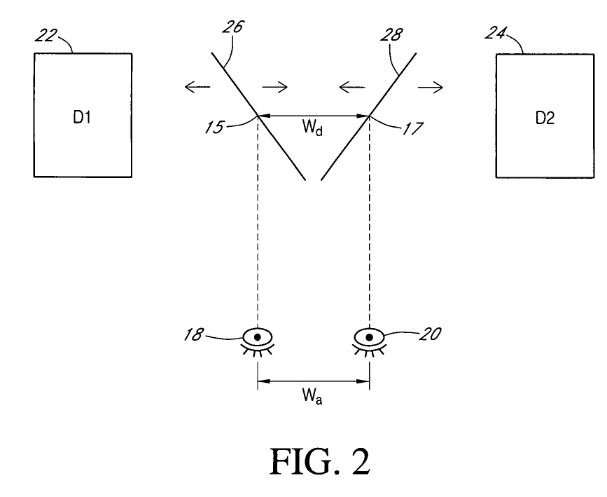

One aspect of the invention provides a 3-D image generation system which adjusts the mirror distance (W_{d}) based on the distance (Wₐ) between a viewer's eyes. FIG. 2 illustrates a 3-D image generation system according to one embodiment of the invention. In one embodiment, the mirror distance (W_{d}) is either manually or automatically adjusted based on the distance (Wₐ) between a viewer's eyes 18 and 20. In one embodiment, the mirror distance value (W_{d}) is adjusted so as to be substantially the same as the eye distance value (Wₐ).

For example, if person A's Wₐ (e.g., 60 mm) is provided to the system, the W_{d} distance is adjusted to be substantially or exactly the same as 60 mm (e.g., 59.5-60.5 mm). As another example, if person B's Wₐ (e.g, 70 mm) is provided to the system, the W_{d} value is adjusted to be substantially or exactly the same as 70 mm (e.g., 69-71 mm). As another example, if person C's Wₐ (e.g., 80 mm) is entered, the mirror distance (W_{d}) is adjusted to be substantially or exactly the same as 80 mm (e.g., 79-81 mm). Throughout the specification, the term “substantially the same” will be interchangeably refer to “substantially or exactly the same.”

In one embodiment, the mirror distance (W_{d}) is initialized as 70 mm. In this embodiment, since the above B's Wₐ value is 70 mm, no adjustment is made to the mirror distance. For the person A, since his Wₐ value is less than the initialized value (70 mm), the mirrors 26 and 28 are moved such that the mirror distance (W_{d}) is narrowed from the initialized state until W_{d} is substantially the same as the A's Wₐ value (60 mm). For the person C, since his Wₐ value (80 mm) is greater than the initialized value (70 mm), the mirror distance (W_{d}) is widened from the initialized state until W_{d} is substantially the same as the A's Wₐ value (80 mm). In this way, the mirror distance (W_{d}) is adjusted so as to be substantially the same as the eye distance value (Wₐ). Thus, a viewer can perceive a sense of three dimensions from the two plane images, displayed on the mirrors 26 and 28, wherein the distance (W_{d}) is substantially the same as the distance (Wₐ).

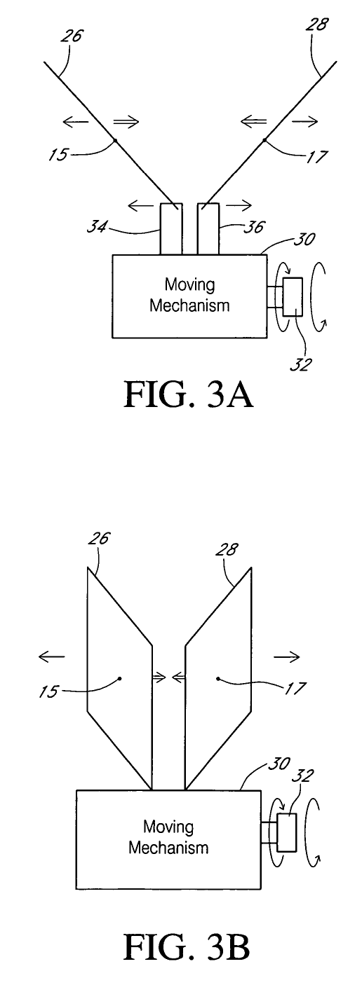

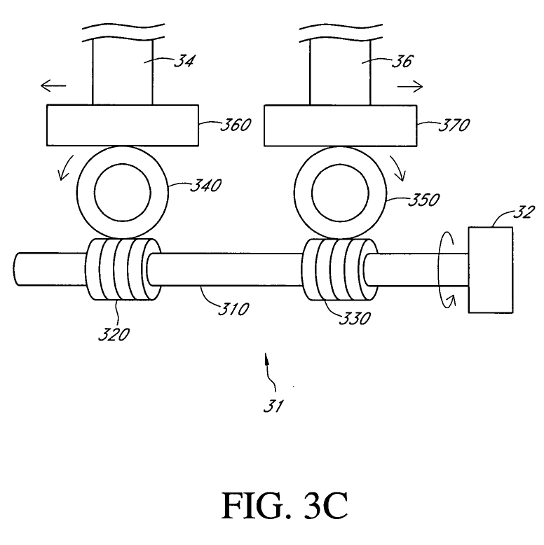

FIGS. 3A and 3B illustrate an exemplary configuration of a moving mechanism (or adjustment mechanism) of a 3-D image generation system according to one embodiment of the invention. FIGS. 3A and 3B represent a plan view and a front view of the moving mechanism, respectively. In one embodiment, the moving mechanism 30 is configured to manually move the pair of mirrors 26 and 28 such that the Wₐ value is substantially the same as the Wₐ value.

In one embodiment, the moving mechanism 30 contains a moving assembly 31 (see FIG. 3C), an adjusting knob 32, and a pair of connecting members 34 and 36. In one embodiment, the adjusting knob 32 and the pair of connecting members 34 and 36 can be formed from a rigid material such as plastic, metal or wood. In one embodiment, the moving assembly 31 is located inside the moving mechanism 30. In one embodiment, the moving assembly 31 moves the mirrors 26 and 28 in a latitudinal direction by the rotation of the adjusting knob 32. The bottom portions of the mirrors 26 and 28 are connected to the top surfaces of the connecting members 34 and 36, respectively (see FIGS. 3A and 3B), such that the mirrors 26 and 28, and the connecting members 34 and 36 can simultaneously move in a latitudinal direction. In one embodiment, one clockwise rotation of the adjusting knob 32 can increase a certain amount, for example, 10 mm, in the W_{d} value. In another embodiment, one counter clockwise rotation of the adjusting knob 32 can decrease the same amount in the W_{d} value.

In one embodiment, the moving assembly 31 includes a connecting rod 310, a pair of worm gears 320 and 330, a pair of wormwheels 340 and 350, and a pair of rack gears 360 and 370. In one embodiment, the connecting rod 310 is extended from the adjusting knob 32, and includes the pair of worm gears 320 and 330. In one embodiment, the worm gears 320 and 330 are integrally formed on the connecting rod 310. The rack gears 360 and 370 are connected to the moving sections 34 and 36, respectively, as shown in FIG. 3C.

The worm gears 320 and 330 are engaged with the wormwheels 340 and 350, respectively. In one embodiment, the first pair of the worm 320 and the wormwheel 340 are configured such that the counter clockwise rotation of the worm 320 moves the wormwheel 340 in a counter clockwise direction as shown in FIG. 3C. In this embodiment, the second pair of the worm 330 and the wormwheel 350 are configured such that the counter clockwise rotation of the worm 330 moves the wormwheel 350 in a clockwise direction as shown in FIG. 3C. This can be implemented by structuring the teeth of each of the first and second pairs in an opposite direction. In another embodiment, the first and second pairs of the worms 320, 330 and wormwheels 340, 350 can be configured such that the clockwise rotation of the worms 320 and 330 rotate the wormwheels 340 and 350 clockwise and counter clockwise, respectively. It will be appreciated that a skilled technologist can easily create various implementations of gear teeth of each worm or wormwheel depending on the embodiment.

The wormwheels 340 and 350 are engaged with the rack gears 360 and 370, respectively, as shown in FIG. 3C. In one embodiment, the rotation of the wormwheels 340 and 350 moves the rack gears 360 and 370 in latitudinal (linear) directions which are opposite to each other as shown in FIG. 3C. That is, the counter clockwise rotation of the wormwheel 340 moves the rack gear 360 in the left direction, and the clockwise rotation of the wormwheel 350 moves the rack gear 370 in the right direction as shown in FIG. 3C. In the above embodiment, the wormwheels 340 and 350 server the role of i) as a wormwheel for the worms 320 and 330, respectively, and ii) a pinion gear for the rack gears 360 and 370, respectively.

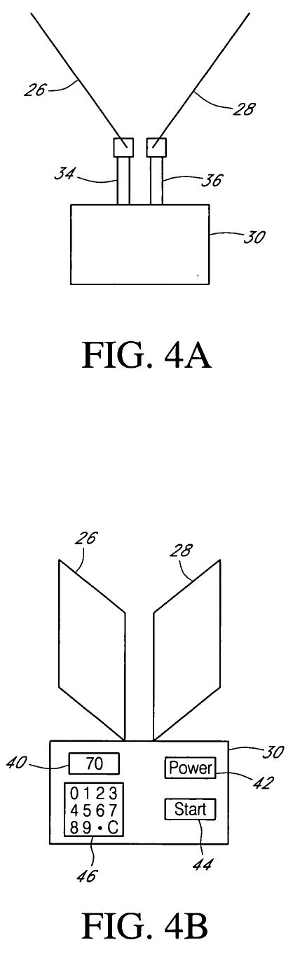

FIG. 4A-4B illustrate an exemplary configuration of a moving mechanism of a 3-D image generation system according to another embodiment of the invention. FIGS. 4A and 4B represent a plan view and a front view of the moving mechanism, respectively. In one embodiment, the moving mechanism 30 is configured to automatically move the pair of mirrors 26 and 28 such that the mirror distance (W_{d}) is equal to or substantially the same as the eye distance (Wₐ). In this embodiment, as shown in FIG. 4B, the moving mechanism 30 includes a display unit 40, a power button 42, a start button 44, and an input unit 46. In one embodiment, the moving mechanism 30 includes a motor and a controller (not shown) which automatically operate the moving assembly 31. In this embodiment, such a motor and controller can be configured to drive, for example, the worm gears 320 and 330. A skilled technologist could readily implement an automatic moving mechanism in view of the manual moving mechanism shown in FIG. 3C, and thus the description thereof will be omitted.

In one embodiment, the display unit 40 displays a mirror adjusting value (W_{d}), to be adjusted, which is provided via the input unit 46. Referring to FIG. 4B, the display unit 40 displays “70 mm.” The power button 42 is to turn on the moving mechanism 30. The start button 44 is to start adjusting the mirrors 26 and 28. Once a mirror adjusting value (W_{d}) is entered and the start button 44 is pressed down, the automatic moving mechanism 30 moves the mirrors 26 and 28 as much as the entered adjustment value, 70 mm in this embodiment. In one embodiment, the display unit 40, the power button 42 and the start button 44 can be omitted. In this embodiment, entering a mirror adjusting value (W_{d}) via the input unit 46 can automatically move the mirrors 26 and 28 as entered.

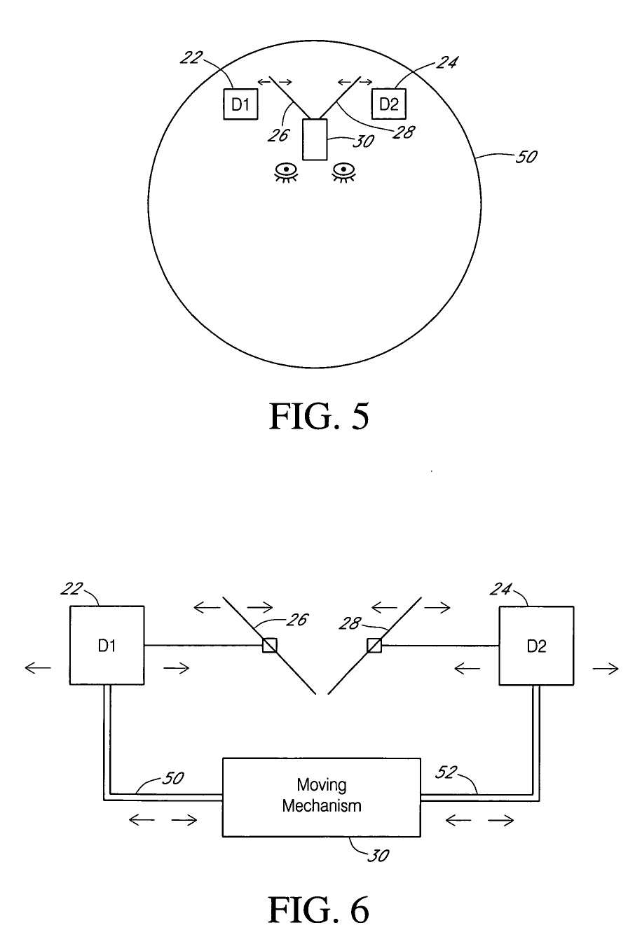

FIG. 5 illustrates an exemplary configuration of a 3-D image generation system according to still another embodiment of the invention. In this embodiment, the system as discussed above is implemented in a head mounted display (50; HMD). In this embodiment, the display devices 22 and 24, the mirrors 26 and 28, and moving mechanism 30 are made relatively smaller than in other embodiments such that those parts (22-30) can fit in the HMD 50.

FIG. 6 illustrates an exemplary configuration of a moving mechanism of a 3-D image generation system according to still another embodiment of the invention. In one embodiment, the moving mechanism 30 is configured to either automatically or manually move both i) the mirrors 26 and 28, and ii) the display devices 22 and 24 such that the W_{d} value is substantially the same as the Wₐ value. In this embodiment, the mirrors 26 and 28 are connected to the display devices 22 and 24 via connecting members 50 and 52 so that the moving mechanism 30 simultaneously moves the devices 22, 24, and the mirrors 26, 28. In one embodiment, the moving mechanism 30 moves either manually or automatically the connecting members 50 and 52 in a latitudinal direction based on the mirror adjusting value (W_{d}) as discussed above.

One advantage of this embodiment is that a stereoscopic image can be provided to the viewer such that a photographing ratio (A:B:C) is substantially the same as a screen ratio (D:E:F). The photographing ratio includes three parameters (A, B, C). Parameters A and B are defined as horizontal and vertical lengths of the space, respectively, including an object, photographed by a camera (not shown). Parameter C is defined as the perpendicular distance between the camera and the object. The screen ratio includes three parameters (D, E, F). Parameters D and E are defined as horizontal and vertical lengths of the image displayed in a display device, respectively. Parameter F is defined as the perpendicular distance between the display device and a viewer's eye. By always maintaining the relationship of the adjustment of being “A:B:C=D:E:F” provides a more realistic 3D image to the viewer. The photographing ratio (A:B:C) and the screen ratio (D:E:F) are described in detail in Applicant's U.S. (published) application Ser. No. 10/280,246, filed on Oct. 24, 2002, which is hereby incorporated by reference.

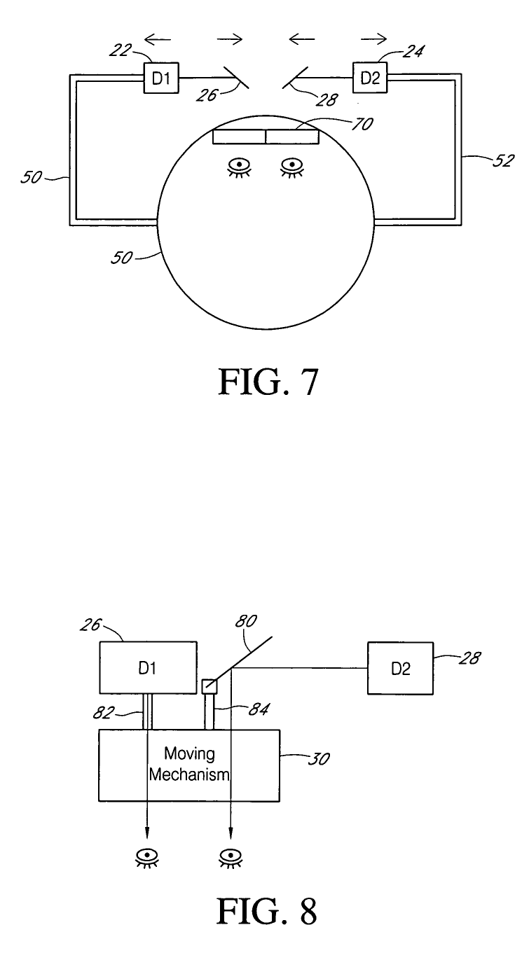

FIG. 7 illustrates an exemplary configuration of a 3-D image generation system according to still another embodiment of the invention. In this embodiment, the FIG. 6 system is implemented with a head mounted display (50; HMD). In this embodiment, the moving mechanism (not shown in FIG. 7) is located inside the HMD 50 and the display devices 22 and 24 are connected to the HMD 50 via the connecting members 50 and 52, respectively. The mirrors 26 and 28 are connected to the display devices 22 and 24, respectively, so that the moving mechanism simultaneously moves the display devices 22 and 24, and the mirrors 26 and 28. In one embodiment, the HMD 50 includes a display guiding portion 70 which facilitates the images to be reflected from the mirrors 26 and 28 to a viewer's eyes, respectively. As in the FIG. 6 embodiment, the moving mechanism can either manually or automatically move the connecting members 50 and 52 in a latitudinal direction.

FIG. 8 illustrates an exemplary configuration of a 3-D image generation system according to still another embodiment of the invention. In this embodiment, only one mirror 80 is provided in the system. The mirror 80 reflects an image incident from the display device 28 (D2) to the viewer's right eye as shown in FIG. 8. In this embodiment, the display device 28 preferably inverts the image before outputting so that a proper orientation of the image by the mirror 80 can be obtained. The moving mechanism 30 moves the mirror 80 and the display device 26 such that the distance value (W_{d}) is substantially the same as the distance value (Wₐ).

The display device 26 (D1) and the mirror 80 are connected to the moving mechanism 30 via connection sections 82 and 84, respectively. In one embodiment, the moving mechanism 30 can move at least one of the display device 26 and the mirror 80 in a latitudinal direction, left and right with respect to the viewer's eyes to satisfy the above relationship (W_{d}=Wₐ).

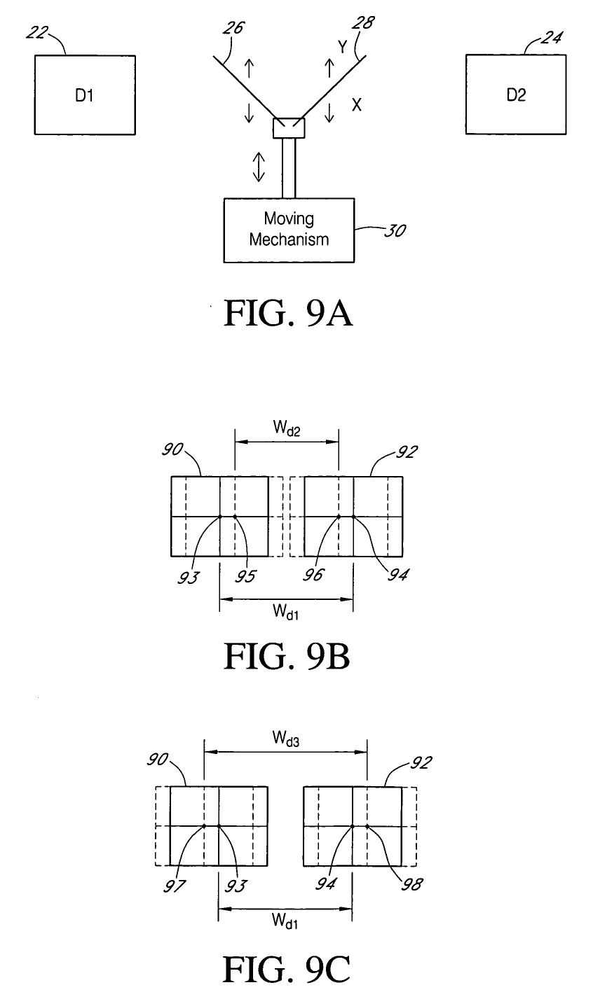

FIG. 9A illustrates an exemplary configuration of a 3-D image generation system according to yet another embodiment of the invention. In this embodiment, the moving mechanism 30 moves both of the mirrors 26 and 28 in a longitudinal direction, i.e., backward or forward (X or Y directions in FIG. 9A) with respect to the viewer's eyes such that the center points of the images displayed on the mirrors 26 and 28 are moved in a latitudinal direction.

In one embodiment, it is assumed that the distance W_{d1}, shown in FIGS. 9B and 9C, is set to as an initial distance, for example, 70 mm. In this embodiment, the movement of the mirrors 26 and 28 in the Y direction provides the same effect of adjusting the initial distance (W_{d1}) to be shorter (W_{d2}), as shown in FIG. 9B. Furthermore, in this embodiment, the movement of the mirrors 26 and 28 in the X direction provides the same effect of adjusting the initial distance (W_{d1}) to be longer (W_{d3}) as shown in FIG. 9C. This adjustment mechanism is disclosed in detail in Applicant's U.S. (published) application Ser. No. 10/280,241, filed on Oct. 24, 2002, which is hereby incorporated by reference.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A system for providing a three dimensional image from at least two plane images, comprising:
first and second image display devices configured to substantially simultaneously output first and second plane images, each plane image produced at different positions with respect to an object;
a first mirror configured such that the output first plane image is incident to the first mirror and reflected in a selected direction;
a second mirror configured such that the output second plane image is incident to the second mirror and reflected in the selected direction; and
an adjustment mechanism configured to adjust the distance between the first and second mirrors,
wherein the first and second display devices are located on opposite sides of the first and second mirrors.

2. The system of claim 1, wherein the adjustment mechanism is further configured to adjust the distance between the first and second mirrors based on the distance between the center points of a viewer's eyes.

3. The system of claim 2, wherein the adjustment mechanism is further configured to move at least one of the first and second mirrors such that the distance between the center points of the displayed images is equal to or substantially the same as the distance between a viewer's eyes.

4. The system of claim 3, wherein the adjustment mechanism is further configured to move at least one of the first and second mirrors in a latitudinal direction.

5. The system of claim 3, wherein the adjust mechanism is further configured to move the first and second mirrors in a longitudinal direction.

6. The system of claim 1, wherein the adjustment mechanism is further configured to move both i) the first and second display devices and ii) the first and second mirrors in a latitudinal direction.

7. The system of claim 6, wherein the first and second display devices are connected to the first and second mirrors, respectively, and wherein the adjustment mechanism is configured to move the display devices in a latitudinal direction so that the devices and mirrors are moved together.

8. The system of claim 1, wherein the adjustment mechanism is further configured to adjust the mirror distance such that the distance between the center points of a viewer's eyes is equal to or substantially the same as the distance between the center points of the displayed images.

9. The system of claim 1, wherein the adjustment mechanism is further configured to adjust the mirror distance either manually or automatically.

10. The system of claim 1, wherein the adjustment mechanism comprises:
a pair of connecting members connected to the first and second mirrors, respectively; and
a moving assembly configured to move the pair of connecting members so as to adjust the mirror distance between the first and second mirrors.

11. The system of claim 10, wherein the moving assembly comprises:
a pair of worm gears;
a pair of wormwheels meshed with the pair of worm gears; and
a pair of rack gears meshed with the pair of wormwheels on one side and connected to the pair of moving sections on the other side, respectively.

12. The system of claim 11, further comprising an adjusting knob configured to manually rotate the worm gears.

13. The system of claim 11, further comprising a servo mechanism configured to automatically rotate the worm gears.

14. The system of claim 11, wherein the system is configured with a head mount display.

15. A method of providing a three dimensional image from at least two plane images, comprising:
substantially simultaneously outputting first and second plane images, each plane image produced at different positions with respect to an object;
configuring a first mirror such that the output first plane image is incident to the first mirror and reflected in a direction;
configuring a second mirror such that the output second plane image is incident to the second mirror and reflected in the direction; and
adjusting the distance between the first and second mirrors such that the distance between the center points of a viewer's eyes is equal to or substantially the same as the distance between the center points of the displayed images.

16. The method of claim 15, wherein the adjusting is made either manually or automatically.

17. The method of claim 15, wherein the adjusting comprises:
receiving an eye distance value indicative of the distance between the center points of a viewer's eyes; and
automatically moving at least one of the first and second mirrors based on the received eye distance value.

18. A system for providing a three dimensional image from at least two plane images, comprising:
a first image display device configured to output a first plane image of an object;
a second image display device configured to output a second plane image of the object, the first and second images being produced at different positions with respect to the object, wherein the first and second image display devices are configured to output substantially simultaneously the first image and the second image, respectively;
a mirror arranged such that the first plane image is incident from the first image display device to the mirror and reflected in a selected direction; and
an adjustment mechanism configured to adjust the distance between the mirror and the second image display device based on the distance between the center points of a viewer's eyes,
wherein the first and second display devices are located on opposite sides of the mirror, and
wherein the second display device is arranged to output the second plane image in the selected direction.

19. The system of claim 18, wherein the adjustment mechanism is further configured to move at least one of the mirror and the second image device such that the distance between i) the center point of the image displayed in the second display device and ii) the center point of the image displayed in the mirror is equal to or substantially the same as the distance between a viewer's eyes.

20. The system of claim 19, wherein the adjustment mechanism comprises:
a pair of connecting members connected to the mirror and the second display device, respectively; and
a moving assembly configured to move the pair of connecting members so as to adjust the mirror distance between the mirror and the second display device.

21. The system of claim 20, wherein the moving assembly comprises:
an input unit configured to receive an eye distance value indicative of the distance between the center points of a viewer's eyes; and
a servo mechanism configured to automatically move at least one of the mirror and the second image display device based on the received eye distance value.

22. A system for providing a three dimensional image from at least two plane images, comprising:
means for substantially simultaneously outputting first and second plane images, each plane image produced at different positions with respect to an object;
means for configuring a first mirror such that the output first plane image is incident to the first mirror and reflected in a direction;
means for configuring a second mirror such that the output second plane image is incident to the second mirror and reflected in the direction; and
means for adjusting the distance between the first and second mirrors such that the distance between the center points of a viewer's eyes is equal to or substantially the same as the distance between the center points of the displayed images.
